(19) United States
(12) Patent Application Publication
(10) Pub. No.: US 2026/0097825 A1
(43) Pub. Date: Apr. 9, 2026

(54) GUIDE UNIT FOR BICYCLE OR MOTORCYCLE FORK TUBES

(71) Applicant: AKTIEBOLAGET SKF, GOTEBORG (SE)

(72) Inventors: Nicolas BERRUET, Artannes sur Indre (FR); Paolo GIRAUDO, Trana (IT)

(21) Appl. No.: 19/347,100

(22) Filed: Oct. 1, 2025

(30) Foreign Application Priority Data
Oct. 8, 2024 (IT) 102024000022365

(51) Int. Cl. B62K 25/06; F16C 33/20

(52) U.S. Cl. CPC B62K 25/06; F16C 33/205

(57) ABSTRACT

A guide unit is for bicycle or motorcycle fork tubes, the fork tube having a longitudinal axis and being provided with two coaxial tubes together defining a cylindrical space, one of which slides telescopically inside the other along the axis by virtue of the interposed guide unit. The guide unit is provided with a pair of sliding bushings radially interposed between the two coaxial tubes and axially spaced apart from each other inside the cylindrical space. Each bushing has a rigid cylindrical body and a sliding lining made of a material with a low friction coefficient and arranged in contact with a respective coaxial tube. A plurality of lubricant reservoirs are formed in the sliding lining and are distributed uniformly on the respective bushings.

### CROSS-REFERENCE

This application claims priority to Italian patent application no. 102024000022365 filed on October 8, 2024, the contents of which are fully incorporated herein by reference.

### BACKGROUND OF THE INVENTION

The present invention relates to a guide unit for bicycle or motorcycle fork tubes.

The fork tubes of bicycle or motorcycle forks have a longitudinal axis and generally include an outer lower and an inner hollow stanchion, which are coaxial to each other and to the longitudinal axis, such that the stanchion can move inside the lower. The movement is enabled by a guide unit, which often includes two sliding bushings interposed between the stanchion and the lower and arranged at a given axial distance from each other, i.e., spaced apart.

Each bushing of the guide unit includes a cylindrical steel body, which provides the bushing with high mechanical strength, and a sliding layer, which is usually made from a heat-resistant polymer arranged in contact with the cylindrical body and defining a cylindrical sliding surface to allow better movement of the stanchion relative to the lower.

The bushings, in particular the respective sliding layers, are typically lubricated with oil that completely fills the cavity of the stanchion and of the lower in which the stanchion slides.

### SUMMARY OF THE INVENTION

The present invention is intended to provide a guide unit for fork tubes that is lighter than conventional guide units, contributing both to environmental sustainability by reducing the amount of oil used in the fork and optimizing the lubrication of the bushings, and also to reducing friction between bushings, lower and stanchion to improve the performance of the fork tubes themselves.

These and other aims and advantages are achieved according to the invention by a guide unit for fork tubes having the features set out in the attached claims.

### BRIEF DESCRIPTION OF THE SEVERAL VIEWS OF THE DRAWINGS

The invention is described below with reference to the attached drawings showing a non-limiting example embodiment thereof, in which:

FIG. 1 is a perspective view, with parts removed for clarity, of a preferred embodiment of a guide unit for bicycle or motorcycle fork tubes according to the present invention;

FIG. 2 and 3 are each a magnified view, with parts removed for clarity, of a first detail of the guide unit in FIG. 1;

FIGS. 4 and 5 are each a magnified view, with parts removed for clarity, of a second detail of the guide unit in FIG. 1; and

FIG. 6 illustrates a preferred alternative embodiment of the detail in FIGS. 4 and 5.

### DETAILED DESCRIPTION OF THE INVENTION

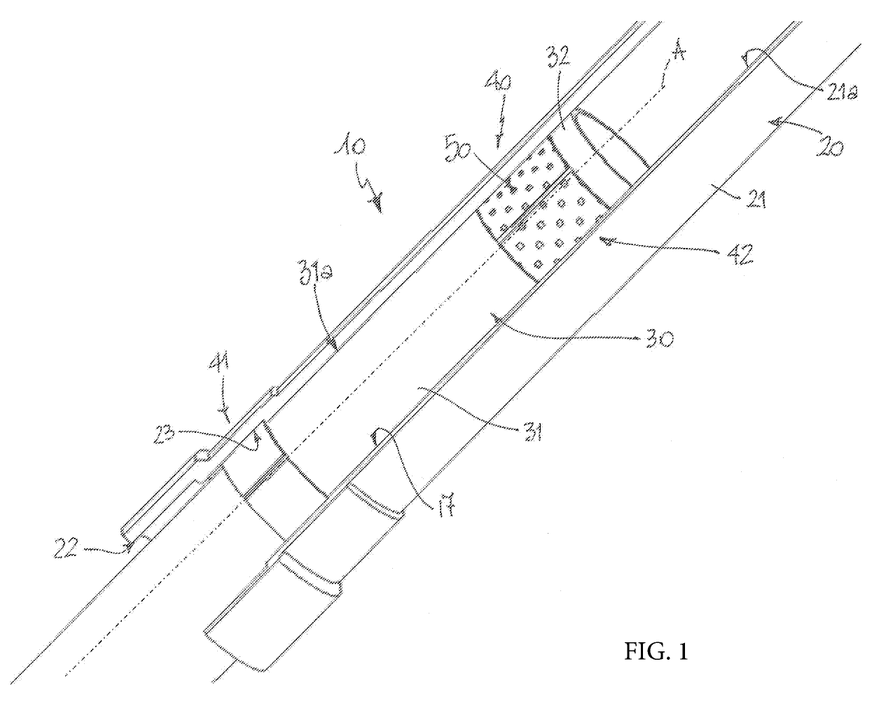

With reference to FIG. 1, reference sign 10 denotes as a whole a fork tube of a bicycle or motorcycle fork (known and not illustrated).

In common usage, the fork tube 10 is intended to form part of a bicycle or motorcycle fork comprising two parallel fork tubes which can be connected to the steerer tube of the bicycle or motorcycle by means of respective plates. The fork tube 10 has a longitudinal axis A and comprises:

two coaxial tubes 20 and 30, one of which slides telescopically inside the other, referred to as the lower 20 and the stanchion 30 in the remainder of this description; and

a guide unit 40 placed between the lower 20 and the stanchion 30 to guide the stanchion 30 inside the lower 20, allowing it to move along the axis A.

The lower 20 is defined by a tubular cylindrical body 21, which has a circular opening 22, and is delimited on the inside by a cylindrical surface 21a. The stanchion 30 is defined by a cylindrical tubular body 31 inserted inside the body 21 through the circular opening 22, and is delimited on the outside by a cylindrical surface 31a facing the surface 21a. The surfaces 21a and 31a of the lower 20 and the stanchion 30, respectively, face each other and together define a cylindrical space or chamber 17, which normally contains a quantity of oil used to minimize the friction between the stanchion 11 and the lower 12 as they slide relative to each other.

The guide unit 40 comprises a pair of sliding bushings 41 and 42, which are radially interposed between the lower 20 and the stanchion 30 with lower or lesser tolerances than the lower 20 and the stanchion 30 themselves, and are axially spaced apart from each other within the cylindrical space 17.

Each bushing 41 and 42 comprises a cylindrical body 43, 44, respectively, made of steel, which gives the particular bushing 41 and 42 high mechanical strength, and a sliding lining 45, 46, respectively, made of a material with a low friction coefficient, such as polytetrafluoroethylene or a heat-resistant polymer, and arranged in contact with the respective cylindrical body 43 and 44 to define a respective cylindrical sliding surface 45a and 46a.

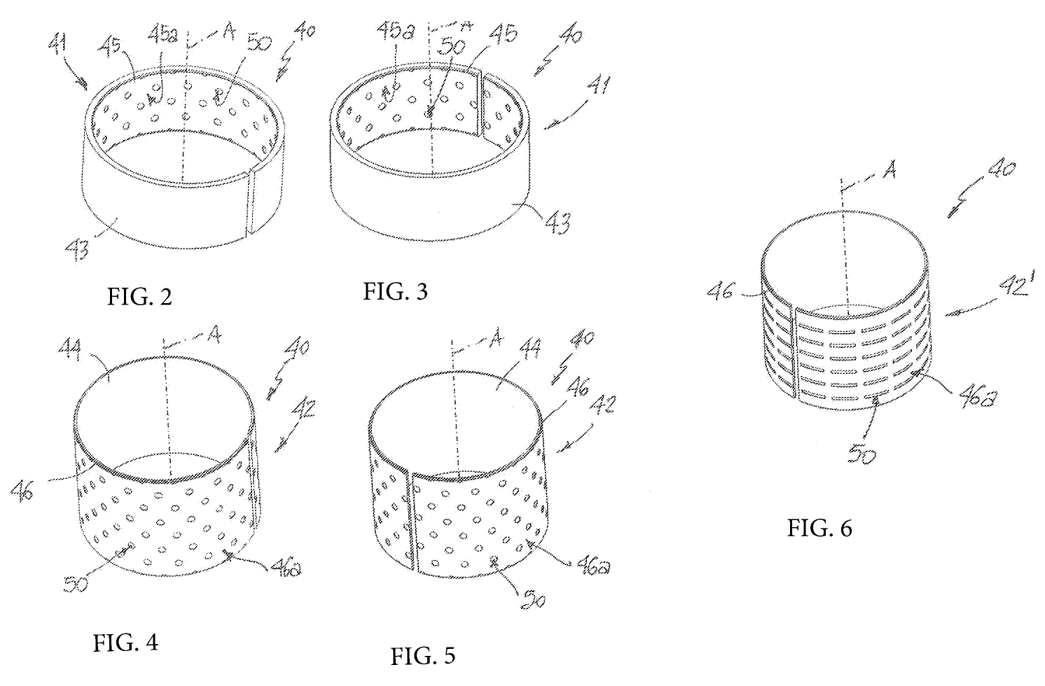

In the exemplary embodiment of the present invention illustrated in FIG. 1, the bushing 41 is arranged close to the circular opening 22 and axially immobilized in a seat 23 formed in the lower 20, is engaged internally and slidingly by the stanchion 30, and, as better illustrated in FIGS. 2 and 3, has the lining 45 arranged internally, i.e. with the surface 45a oriented and facing radially toward, and in sliding contact with, the surface 31a of the stanchion 30.

On the other hand, the bushing 42 is placed near a distal portion 32 of the tubular cylindrical body 31, is axially immobilized on the body 31 itself, and is engaged externally and slidingly with the lower 20. As illustrated more clearly in FIGS. 4 and 5, the lining 46 is arranged on the outside of the bushing 42, i.e. with the surface 46a oriented and facing radially toward, and in sliding contact with, the cylindrical surface 21a of the lower 20.

The bushings 41 and 42 each have a different axial height H1, H2, respectively, with the height H1 preferably being greater than the height H2. The two bushings 41 and 42 each perform similar, but not identical, tasks precisely by virtue of their axial positioning along the axis A within the cylindrical space 17. The bushings 41 and 42, in particular the respective sliding linings 45 and 46, are further lubricated by oil within the cylindrical space 17. However, to both reduce the amount of oil used in the fork tube 10 and to optimize the lubrication of the bushings 41 and 42 themselves, they are provided with a plurality of lubricant reservoirs 50 formed in the related sliding lining 45 and 46 and uniformly distributed on the respective sliding surfaces 45a and 46a.

The lubricant reservoirs 50, as illustrated in FIGS. 2-5, are preferably formed through the sliding linings 45 and 46, and are defined by blind-bottom cavities, preferably but not necessarily circular, distributed in a quincunx arrangement. This arrangement, as well as the shape of the blind-bottom cavities, may vary depending on application requirements, i.e. depending on the size of the fork tube 10.

By way of non-limiting example, FIG. 6 shows a bushing 42’ that is entirely identical to the bushing 42 described above, the bushing 42’ differing therefrom in that the lubricant reservoirs 50 are defined by elongated blind-bottom cavities extending along respective rows of the cylindrical body 44 and also distributed circumferentially in columns, in which the lubricating reservoirs 50 of each column are arranged at the same axial distance from the lubricating reservoirs 50 in the same column. The same distribution can also be applied to the bushing 41 and the inner lining 45 thereof, and the guide unit 40 itself can have bushings with quincunx reservoirs coupled with bushings with reservoirs arranged in columns, and the circular reservoirs 50 can be organized in rows and in columns.

The distinctive features of the lubricant reservoirs 50 are that they accumulate lubricant which can be released when there is not enough lubricant in the cylindrical space 17, and that they reduce friction between the sliding surfaces 45a, 46a and the respective surfaces 21a, 31a on account of the increased amount of lubricant available, and prevent potential seizing between the surfaces 45a, 46a and the surfaces 21a, 31a again precisely due to the increased amount of lubricant available. Furthermore, the reservoirs 50, by being formed through the lining layer 45 and 46, have, first and foremost, a further beneficial effect on the reduction of friction since the presence of the reservoirs 50 actually reduce the total surface area of the sliding surface 45a and 46a, i.e. the surface areas between the reservoirs 50 which make contact with the surfaces 21a, 31a.

It is understood that the invention is not limited to the embodiments described and illustrated here, which are to be considered as example embodiments of the guide unit for the fork tubes of bicycle or motorcycle forks, and may be subject to changes to the form and arrangement of parts, structural and functional details, and materials used. For example, the invention can be applied equally to both upside-down (USD, i.e. inverted stanchions) fork tubes and traditional fork tubes. It will also be clear that the invention can also be used in single-sided telescopic hydraulic forks. The invention can also be implemented with sliding and/or rotary forks. The invention is understood to encompass all variants within its scope, as defined by the following claims.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A guide unit for fork tubes of bicycle or motorcycle forks, the fork tube having a longitudinal axis and including two coaxial tubes, a cylindrical space being defined between the two coaxial tubes and one of the two coaxial tubes telescopically sliding inside the other one of the two coaxial tubes along the axis, the guide unit comprising:
a pair of sliding bushings radially interposed within the cylindrical space between the two coaxial tubes so as to be axially spaced apart from each other, each sliding bushing including a rigid cylindrical body and a sliding lining attached to the rigid cylindrical body, each sliding lining being made of a low friction coefficient material, each sliding lining of the pair of sliding bushings being arranged in contact with a separate one of the two coaxial tubes and including a plurality of lubricant reservoirs, the plurality of lubricant reservoirs being formed in the sliding lining so as to be uniformly distributed about the bushing.

2. The guide unit according to claim 1, wherein the plurality of lubricant reservoirs of each one of the pair of sliding bushings extend into the sliding lining of the bushing and each one of the plurality of lubricant reservoirs is defined by a blind-bottom cavity.

3. The guide unit according to claim 2, wherein the plurality of lubricant reservoirs are circular in shape.

4. The guide unit according to claim 3, wherein the plurality of lubricant reservoirs are elongated in shape.

5. The guide unit according to claim 3, wherein the plurality of lubricant reservoirs are distributed in a quincunx arrangement.

6. The guide unit according to claim 3, wherein the plurality of lubricant reservoirs are distributed along respective rows of the bushing and are also distributed along circumferentially equally spaced columns, wherein the lubricant reservoirs of each column are axially equally spaced apart from the lubricant reservoirs of the same column.

7. The guide unit according to claim 1, wherein the rigid cylindrical body of each bushing of the pair of sliding bushings is made of steel to provide high mechanical strength to the bushing and the sliding lining of each bushing of the pair of sliding bushings is made of a low friction coefficient material.

8. The guide unit according to claim 7, wherein the low friction coefficient material is a heat-resistant polymer.

9. The guide unit according to claim 1, wherein the sliding lining of one of the pair of sliding bushings is arranged on an inside of the cylindrical body of the bushing and is in sliding contact with an inner one of the two coaxial tubes and the sliding lining of the other one of the pair of sliding bushings is arranged on an outside of the cylindrical body of the bushing and is in sliding contact with an outer one of the two coaxial tubes.

10. A bicycle or motorcycle fork tube including a guide unit according to claim 1.
